(19) United States
(12) Patent Application Publication
(10) Pub. No.: US 2004/0144210 A1
(43) Pub. Date: Jul. 29, 2004

(54) Apparatus for removing a cork from a bottle

(75) Inventor: Isador H. Lieberman, Pepper Pike, OH (US)

Correspondence Address: TAROLLI, SUNDHEIM, COVELL & TUMMINO L.L.P., SUITE 1111, 526 SUPERIOR AVENUE, CLEVELAND, OH, 44114-1400, US

(73) Assignee: Inventia Product Development LLC

(21) Appl. No.: 10/743,568

(22) Filed: Dec. 22, 2003

Related U.S. Application Data
(60) Provisional application No. 60/436,922, filed on Dec. 27, 2002.

(51) Int. Cl. B67B 7/62

(52) U.S. Cl. 81/3.37

(57) ABSTRACT

An apparatus for removing a cork from a mouth of a bottle comprises a member for engaging the mouth of the bottle and a handle connected to the member and movable relative to the member. A shaft is operatively coupled with the handle so that movement of the handle rotates the shaft. The shaft includes two helical spikes extending around a common longitudinal axis. The helical spikes embed into the cork upon rotation of the shaft through movement of the handle. The helical spikes, when embedded in the cork, are resistant to toggling in the cork and to being pulled axially from the cork which can cause the cork to break into multiple pieces. The apparatus is particularly useful for removing a cork in an oversized wine bottle, such as a magnum.

### RELATED APPLICATIONS

The present application claims the benefit of U.S. Provisional Patent Application Serial No. 60/436,922, entitled APPARATUS FOR REMOVING A CORK FROM A BOTTLE, filed Dec. 27, 2002.

### TECHNICAL FIELD

The present invention is directed to an apparatus for removing a cork from a bottle, and is particularly useful for removing a cork from an oversized bottle.

### BACKGROUND OF THE INVENTION

It is common practice to utilize a cork to close and seal a bottle containing liquid, such as wine, for an extended period of time. Such a cork fits tightly (i.e. an interference fit) within the mouth of the bottle and requires a tool for removal. A wide variety of tools for removing corks are known, many of which utilize a single helical screw or worm that penetrates into the cork with sufficient purchase to withstand the force required to pull the cork from the bottle yet still remain embedded in the cork.

Oversized bottles, such as magnums, double magnums, and the like, can be more difficult to remove the cork from due to the larger sizes of the mouths of the bottles and corresponding corks. When the known cork removal tools are used to remove a cork from such an oversized bottle, it is common for the cork to tear or break into multiple pieces. Such tearing of the cork can complicate the cork removal process and result in pieces of the cork falling into the liquid inside the bottle. Hence, a need exists for an apparatus for removing a cork from an oversized bottle and which avoids tearing or breaking the cork during the removal process.

### SUMMARY OF THE INVENTION

The present invention is an apparatus for removing a cork from inside a mouth of a bottle. The apparatus comprises at least one member for engaging the outside of the mouth of the bottle and at least one handle connected to the at least one member and movable relative to the at least one member. A shaft is operatively coupled with the at least one handle so that movement of the at least one handle rotates the shaft. The shaft includes at least two helical spikes projecting from an end portion of the shaft and extending around a common longitudinal axis. The at least two helical spikes embed into the cork upon rotation of the shaft through movement of the at least one handle. The at least two helical spikes, when embedded in the cork, are resistant to toggling in the cork and to being pulled axially from the cork which can cause the cork to break into multiple pieces.

In accordance with one aspect of the invention, the at least two helical spikes comprise a pair of intertwined corkscrews.

In accordance with another aspect of the invention, the bottle has an oversized mouth and the cork is correspondingly oversized. The at least one member is adapted to mate with the oversized mouth of the bottle.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a side view of an apparatus for removing a cork from a bottle in accordance with a first embodiment of the present invention;

FIG. 2 is an end view of the apparatus of FIG. 1 taken along line 2-2;

FIG. 3 is an enlarged view of a portion of the apparatus of FIG. 1;

FIG. 4 is a sectional view taken along line 4-4 in FIG. 3;

FIG. 5 is a side view illustrating an alternate configuration for a portion of the apparatus of FIG. 1;

FIG. 6 is a side view of an apparatus for removing a cork from a bottle in accordance with a second embodiment of the present invention;

FIG. 7 is a side view of an apparatus for removing a cork from a bottle in accordance with a third embodiment of the present invention;

FIG. 8 is a perspective view of the apparatus of FIG. 7 showing parts of the apparatus in different positions; and

FIG. 9 is a side view of an apparatus for removing a cork from a bottle in accordance with a fourth embodiment of the present invention.

### DETAILED DESCRIPTION OF EMBODIMENTS

The present invention is directed to an apparatus for removing a cork from a bottle, and is particularly useful for removing a cork from an oversized bottle. As representative of the present invention, FIG. 1 illustrates an apparatus 10 for removing a large cork 12 from a mouth 14 of an oversized bottle 16, such as a magnum of wine, in accordance with a first embodiment. The apparatus comprises a handle 20, a lever 30, and a shaft 40 centered about a longitudinal axis 42.

The handle 20 is manually engagable by the user and may be made from any suitable material. The handle has oppositely disposed first and second ends 22 and 24 and main body portion 26 between the ends. The lever 30 is pivotally attached to the first end 22 of the handle 20. The lever 30 has an end portion 32 for engaging the outside of the mouth 14 of the bottle 16. The lever 30 may also include a bottle cap opening portion 34. A blade or cutting member 36 may be pivotally attached to the second end 24 of the handle 20.

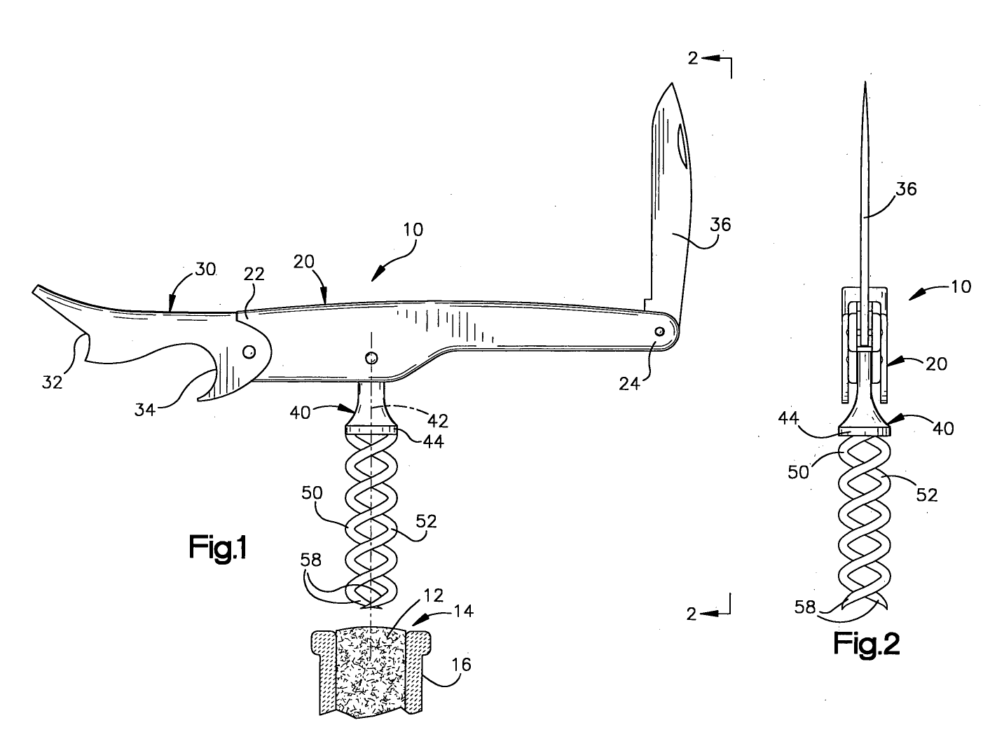

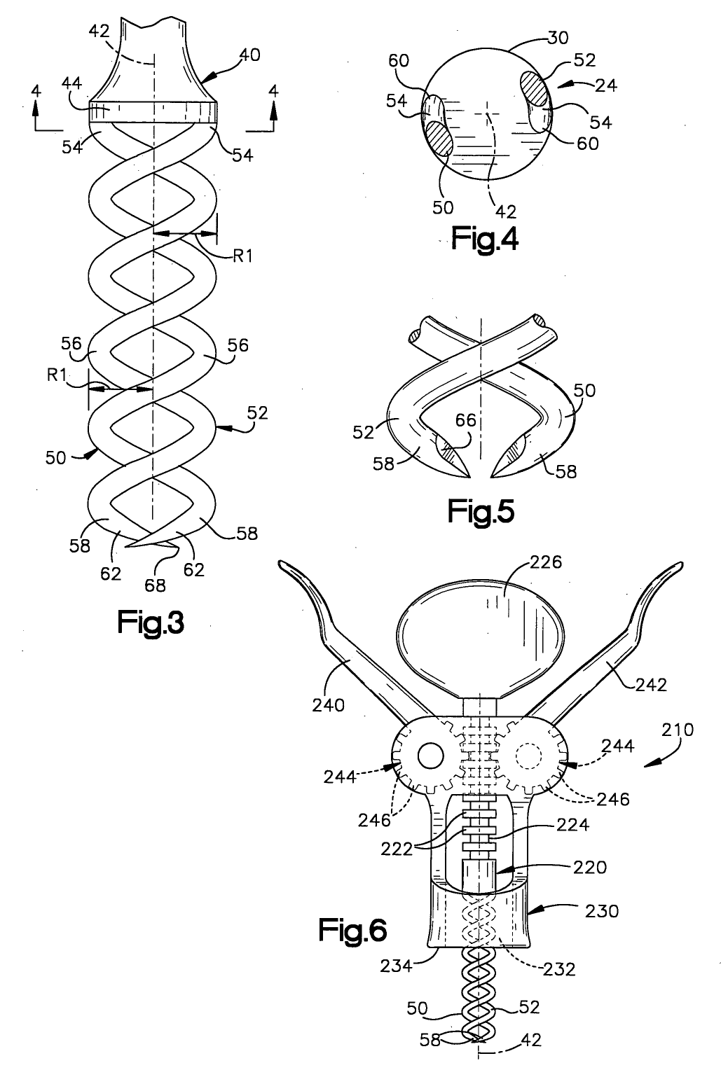

The shaft 40 is pivotally attached to the main body portion 26 of the handle 20. First and second helical spikes 50 and 52 project from an end portion 44 of the shaft 40. The helical spikes 50 and 52 comprise a pair of intertwined corkscrews. According to the embodiment illustrated in FIGS. 1-4, the first and second helical spikes 50 and 52 extend around the axis 42. The spikes 50 and 52 extend in a helical pattern about the axis 42 at the same, constant radius R1. The radius of the helical spikes 50 and 52 should be selected so that the spikes will fit into a cork in a standard 750 ml bottle but are also well suited for removing a cork from an oversized bottle.

It is contemplated, however, that the first and second helical spikes 50 and 52 could extend about the axis 42 at different radiuses. Further, it is contemplated that the radius of one or both of the first and second helical spikes 50 and 52 could increase or decrease as the helical spikes extend away from the end portion 44 of the shaft 40.

In the illustrated embodiment of FIGS. 1-4, the first and second helical spikes 50 and 52 have the same axial length, and also have the same circular cross-sectional shape. It is contemplated, however, that the first and second helical spikes 50 and 52 could have different axial lengths. Further, it is contemplated that the helical spikes 50 and 52 could have a different cross-sectional shape, such as an oval shape. It also contemplated that the first and second helical spikes 50 and 52 could have different cross-sectional areas (i.e., one spike being thicker than the other spike), and that the helical spikes could be either solid or hollow in cross-section. Finally, the helical spikes 50 and 52 shown in FIG. 1 have the same pitch, but this is not required.

Each of the first and second helical spikes 50 and 52 can be divided into three portions: a connecting portion 54, an intermediate portion 56, and a tip portion 58. The connecting portion 54 of each of the helical spikes 50 and 52 is located at a proximal end 60 that adjoins the end portion 44 of the shaft 40. According to one method for manufacturing the apparatus 10, the connecting portion 54 of each of the helical spikes 50 and 52 is fixedly attached to the shaft 40 by inserting, in a tangential direction, the proximal ends 60 of the helical spikes into openings (not shown) in the end portion 44 and welding the connecting portions 54 to the shaft. The inserted proximal ends 60 of the helical spikes 50 and 52 help to reduce tensile bending stresses on the helical spikes under tensile (or pull-out) loads.

Alternatively, the helical spikes 50 and 52 may be formed integrally with the shaft 40, such as by casting. If the shaft 40 is cast, it is contemplated that a fillet (not shown) may be added at the junction of the helical spikes 50 and 52 and the end portion 42 to strengthen the junction and minimize stress concentrations at the connecting portions 54. The fillet at the junction of the helical spikes 50 and 52 and the end portion 42 also helps to reduce bending stresses in the connection portions 54 of the helical spikes under tensile (or pull-out) loads.

As best seen in FIG. 4, the connecting portions 54 at the proximal ends 60 of the first and second helical spikes 50 and 52 are spaced 180° apart about the axis 42 to balance the apparatus 10 and evenly distribute loads on the helical spikes. It is contemplated that the apparatus 10 could have more than two helical spikes spaced evenly apart about the axis 42.

The tip portion 58 of each of the helical spikes 50 and 52 is located at a distal end 62 of the helical spikes. The intermediate portion 56 of each of the helical spikes 50 and 52 extends between the tip portion 58 and the connecting portion 54. The intermediate portion 56 and the tip portion 58 of each of the helical spikes 50 and 52 has a cross-sectional diameter that is less than or equal to the cross-sectional diameter of the connecting portions 54 to help provide the apparatus 10 with increased tensile strength at the junction of the helical spikes and the end portion 44.

The tip portion 58 of each of the helical spikes 50 and 52 illustrated in FIGS. 1-4 has an elongated conical shape with a sharp pointed tip 68 for penetrating into the cork 12 as the shaft 40 of the apparatus 10 is rotated in a clockwise direction. FIG. 5 illustrates an alternative, self-tapping configuration for the tip portions 58 which includes a planar surface 66 for driving into the cork 12, in the same manner that a wood chisel turned upside-down drives into wood, as the shaft 40 is rotated. It is contemplated that the tip portions 58 could also have a pyramid shape (not shown), similar to the tip of a nail.

To remove the cork 12 from the bottle 16 using the apparatus 10, the tip portions 58 of the helical spikes 50 and 52 are pressed against the upper surface of the cork. The handle 20 is then rotated, causing the shaft 40 to rotate as well. Rotation of the shaft 40 screws the helical spikes 50 and 52 into the cork 12 and embeds the spikes into the cork.

With the helical spikes 50 and 52 embedded into the cork 12, the cork is removed by manually pulling on the handle 20 in the axial direction. During this pulling process, substantial forces are placed on the cork 12 which can result in tearing or breaking of the cork. However, due to the twin helical spike design of the apparatus 10, these forces are distributed over the entire width and length of the cork by the two helical spikes 50 and 52. This force distribution prevents tearing and/or breaking of the cork 12 while the cork is being pulled from the mouth 14 of the bottle 16. Thus, the two helical spikes 50 and 52 provide the apparatus 10 with a high resistance to pull-out forces which can destroy the cork 12. Further, the helical spikes 50 and 52 provide a high resistance to toggling when they are embedded in the cork 12.

FIG. 6 illustrates an apparatus 210 constructed in accordance with a second embodiment of the present invention. In the second embodiment of FIG. 6, reference numbers that are the same as those used in the first embodiment of FIGS. 1-4 designate parts that are the same as parts in the first embodiment.

According to the second embodiment, the apparatus 210 comprises a shaft 220, a base member 230, and a pair of oppositely disposed handles 240 and 242. The base member 230 is generally tubular in shape and includes a central passage 232 through which the shaft 220 extends. The base member further includes an end portion 234 for engaging the mouth 14 of the bottle 16.

The handles 240 and 242 are pivotally mounted to the base member 230 and are disposed on opposite sides of the shaft 220 that extends through the base member. Each of the handles 240 and 242 includes a gear wheel 244 with teeth 246 located at the connection of the handle to the base member 230. The teeth 246 are meshing engagement with rack teeth 222 that extend along the outer surface of a main body portion 224 of the shaft 220.

In addition to the rack teeth 222, the shaft 220 includes a manually engagable knob 226 the an upper end of the shaft and first and second helical spikes 50 and 52 that project from the lower end of the shaft. As described previously, the helical spikes 50 and 52 comprise a pair of intertwined corkscrews that extend around the axis 42.

To remove the cork 12 from the bottle 16 using the apparatus 210, the tip portions 58 of the helical spikes 50 and 52 are pressed against the upper surface of the cork. The knob 226 is then rotated, causing the shaft 220 to rotate as well. Rotation of the shaft 220 screws the helical spikes 50 and 52 into the cork 12 and embeds the spikes into the cork.

With the helical spikes 50 and 52 embedded into the cork 12, the cork is removed by manually rotating the handles 240 and 242 downward from the position shown in FIG. 6, which causes the shaft 220 to moved axially upward by virtue of the engaged gear teeth 246 and rack teeth 222. During this pulling process, substantial forces are placed on the cork 12 which can result in tearing or breaking of the cork. However, due to the twin helical spike design of the apparatus 210, these forces are distributed over the entire width and length of the cork by the two helical spikes 50 and 52. This force distribution prevents tearing and/or breaking of the cork 12 while the cork is being pulled from the mouth 14 of the bottle 16. Thus, the two helical spikes 50 and 52 provide the apparatus 210 with a high resistance to pull-out forces which can destroy the cork 12. Further, the helical spikes 50 and 52 provide a high resistance to toggling when they are embedded in the cork 12.

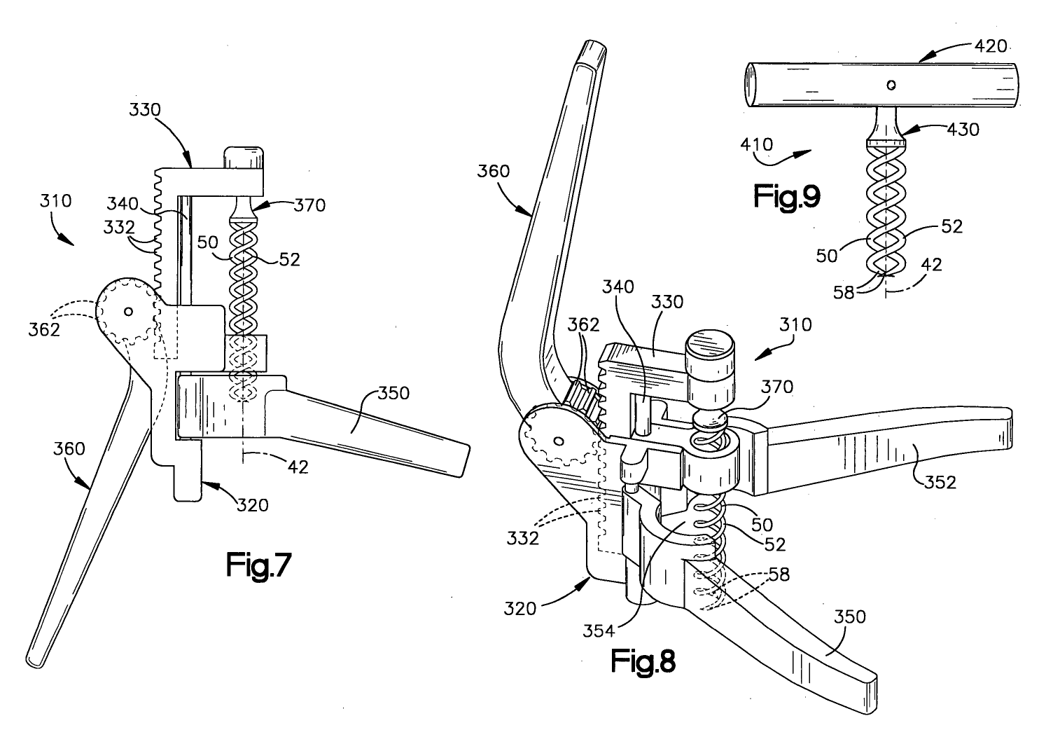

FIGS. 7 and 8 illustrate an apparatus 310 constructed in accordance with a third embodiment of the present invention. In the third embodiment of FIGS. 7 and 8, reference numbers that are the same as those used in the first embodiment of FIGS. 1-4 designate parts that are the same as parts in the first embodiment.

According to the third embodiment, the apparatus 310 comprises a frame 320 and a support member 330 connected by an axially extending rod 340. The apparatus 310 further includes a pair of clamping arms 350 and 352, a handle 360, and a shaft 370.

The support member 330 has an inverted L-shape and is movable relative to the frame 320. The shaft 370 is mounted to and projects downwardly from the support member 330 as may be seen in FIGS. 7 and 8. The support member 330 includes a row of axially extending rack teeth 332 facing towards the handle 360.

The handle 360 is pivotally mounted to the frame 320. The handle 360 includes gear teeth 362 that are in meshing engagement with the rack teeth 332 on the support member 330 so that rotation of the handle about its pivotal connection to the frame causes axial movement of the support member and the shaft 370 attached thereto. As described previously, first and second helical spikes 50 and 52 project from the shaft. The helical spikes 50 and 52 comprise a pair of intertwined corkscrews that extend around the axis 42.

The clamping arms 350 and 352 are hingedly attached to the frame 320 about the rod 340. The arms 350 and 352 define an opening 354 (FIG. 8) for receiving the mouth 14 of the bottle 16 and through which the helical spikes 50 and 52 project.

To remove the cork 12 from the bottle 16 using the apparatus 310, the apparatus is placed in the position shown in FIG. 7 and the tip portions 58 of the helical spikes 50 and 52 are pressed against the upper surface of the cork. The handle 360 is then rotated in a clockwise direction, causing the support member 330 to move axially downward. This downward motion pushes the shaft 370 downward and drives the helical spikes 50 and 52 into the cork 12.

With the helical spikes 50 and 52 embedded into the cork 12, the cork is removed by manually rotating the handle 360 counterclockwise relative to the frame 320, which moves the support member 330 and the shaft 370 axially in an upward direction and pulls the cork from the mouth 14 of the bottle 16. During this pulling process, substantial forces are placed on the cork 12 which can result in tearing or breaking of the cork. However, due to the twin helical spike design of the apparatus 310, these forces are distributed over the entire width and length of the cork by the two helical spikes 50 and 52. This force distribution prevents tearing and/or breaking of the cork 12 while the cork is being pulled from the mouth 14 of the bottle 16. Thus, the two helical spikes 50 and 52 provide the apparatus 310 with a high resistance to pull-out forces which can destroy the cork 12. Further, the helical spikes 50 and 52 provide a high resistance to toggling when they are embedded in the cork 12.

FIG. 9 illustrates an apparatus 410 constructed in accordance with a fourth embodiment of the present invention. In the fourth embodiment of FIG. 9, reference numbers that are the same as those used in the first embodiment of FIGS. 1-4 designate parts that are the same as parts in the first embodiment.

According to the fourth embodiment, the apparatus 410 comprises a handle 420 and a shaft 430 projecting from the handle. As with the previous embodiments, first and second helical spikes 50 and 52 project from an end portion of the shaft 430.

To remove the cork 12 from the bottle 16 using the apparatus 410, the tip portions 58 of the helical spikes 50 and 52 are pressed against the upper surface of the cork. The handle 420 is then rotated, causing the shaft 430 to rotate as well. Rotation of the shaft 430 screws the helical spikes 50 and 52 into the cork 12 and embeds the spikes into the cork.

With the helical spikes 50 and 52 embedded into the cork 12, the cork is removed by manually pulling on the handle 420 in the axial direction. During this pulling process, substantial forces are placed on the cork 12 which can result in tearing or breaking of the cork. However, due to the twin helical spike design of the apparatus 410, these forces are distributed over the entire width and length of the cork by the two helical spikes 50 and 52. This force distribution prevents tearing and/or breaking of the cork 12 while the cork is being pulled from the mouth 14 of the bottle 16. Thus, the two helical spikes 50 and 52 provide the apparatus 410 with a high resistance to pull-out forces which can destroy the cork 12. Further, the helical spikes 50 and 52 provide a high resistance to toggling when they are embedded in the cork 12.

From the above description of the invention, those skilled in the art will perceive improvements, changes and modifications. Such improvements, changes and modifications within the skill of the art are intended to be covered by the appended claims.

Having described the invention, I claim:

1. An apparatus for removing a cork from inside a mouth of a bottle, said apparatus comprising:
at least one member for engaging the outside of the mouth of the bottle;
at least one handle connected to said at least one member and movable relative to said at least one member; and
a shaft operatively coupled with said at least one handle so that movement of said at least one handle rotates said shaft, said shaft including at least two helical spikes projecting from an end portion of said shaft and extending around a common longitudinal axis, said at least two helical spikes for embedding into the cork upon rotation of said shaft through movement of said at least one handle;
said at least two helical spikes, when embedded in the cork, being resistant to toggling in the cork and to being pulled axially from the cork which can cause the cork to break into multiple pieces.

2. The apparatus of claim 1 wherein said at least two helical spikes comprise a pair of intertwined corkscrews.

3. The apparatus of claim 1 wherein the bottle has an oversized mouth and the cork is correspondingly oversized, said at least one member being adapted to mate with the oversized mouth of the bottle.

4. The apparatus of claim 1 wherein each of said at least two helical spikes has a proximal end and a distal end, each of said at least two helical spikes further including a tip portion at said distal end which penetrates into the cork as said shaft is rotated and a connecting portion at said proximal end that is connected to said shaft.

5. The apparatus of claim 4 wherein said tip portion of each of said at least two helical spikes has an elongated conical shape with a sharp pointed tip that penetrates into the cork as said shaft is rotated.

6. The apparatus of claim 4 wherein said tip portion of each of said at least two helical spikes has a self-penetrating terminal end that includes a planar surface for driving into the cork as said shaft is rotated.

7. The apparatus of claim 1 wherein said at least one member comprises a lever pivotally attached to said at least one handle.

8. The apparatus of claim 1 wherein said shaft is pivotally attached to said at least one handle.

9. The apparatus of claim 1 wherein said at least one handle is rotated manually to cause said at least two helical spikes to rotate and embed into the cork.

10. The apparatus of claim 9 wherein, after said at least two helical spikes have been embedded in the cork, the cork is removed by manually pulling axially on said at least one handle.

11. The apparatus of claim 1 wherein said shaft is rotated manually to cause said at least two helical spikes to rotate and embed into the cork.

12. The apparatus of claim 11 wherein said at least one handle comprises a pair of oppositely disposed handles pivotally mounted to said at least one member.

13. The apparatus of claim 12 wherein each of said pair of handles includes gear teeth that are in meshing engagement with rack teeth disposed on said shaft so that rotation of said pair of handles about their pivotal connection to said member causes axial movement of said shaft.

14. The apparatus of claim 13 wherein, after said at least two helical spikes have been embedded in the cork, the cork is removed by manually rotating said pair of handles which pulls axially on said shaft.

15. The apparatus of claim 1 further comprising a frame and a support member connected by an axially extending rod, said support member being movable relative to said frame, said shaft being mounted to and projecting from said support member.

16. The apparatus of claim 15 wherein said at least one member comprises a pair of clamping arms hingedly attached to said frame, said pair of arms defining an opening for receiving the mouth of the bottle and through which said at least two helical spikes project.

17. The apparatus of claim 15 wherein said at least one handle is pivotally mounted to said frame.

18. The apparatus of claim 17 said at least one handle includes gear teeth that are in meshing engagement with rack teeth disposed on said support member so that rotation of said at least one handle about its pivotal connection to said frame causes axial movement of said shaft for embedding said at least two helical spikes into the cork.

19. The apparatus of claim 18 wherein, after said at least two helical spikes have been embedded in the cork, the cork is removed by manually rotating said at least one handle relative to said frame which moves said support member and said shaft axially in an upward direction.

20. An apparatus for removing a cork from inside a mouth of a bottle, said apparatus comprising:
a manually rotatable handle; and
a shaft operatively coupled with said at least one handle so that movement of said at least one handle rotates said shaft, said shaft including at least two helical spikes projecting from an end portion of said shaft and extending around a common longitudinal axis, said at least two helical spikes for embedding into the cork upon rotation of said shaft through movement of said at least one handle;
said at least two helical spikes, when embedded in the cork, being resistant to toggling in the cork and to being pulled axially from the cork which can cause the cork to break into multiple pieces.

21. The apparatus of claim 20 further comprising at least one member for engaging the mouth of the bottle, said at least one handle being connected to said at least one member and being movable relative to said at least one member.
